(19) United States
(12) Patent Application Publication
(10) Pub. No.: US 2012/0314850 A1
(43) Pub. Date: Dec. 13, 2012

(54) SYSTEM OF HARDWARE, SOFTWARE AND TECHNICAL METHODS TO ENABLE ACTIVE MANAGEMENT OF ON HOLD CALLS ON SMART PHONES AND OTHER PROGRAMMABLE PHONES

(76) Inventors: Thomas Love, Cromwell, CT (US); Paul James, Ware, MA (US); Matthew Cerullo, Cheshire, CT (US)

(21) Appl. No.: 13/492,246

(22) Filed: Jun. 8, 2012

Related U.S. Application Data
(60) Provisional application No. 61/494,603, filed on Jun. 8, 2011.

(51) Int. Cl. H04M 11/00; H04M 1/00

(52) U.S. Cl. 379/93.17; 379/93.01; 379/419

(57) ABSTRACT

The described embodiment of the system relates to software and hardware related to smart phones and programmable phones, on hold messages, putting callers on hold and taking them off hold, visual indications on such phones of the active inactive status of callers who are on hold, and key pad communication.

### FIELD OF THE INVENTION

This provisional patent application relates to smart phones and other programmable phones and management of on hold phone calls, including visual indications of active and passive status of on hold calls and customized on hold messages to callers.

### BACKGROUND OF THE INVENTION

1. Description of Related Art

With the advent of smart phones that visually indicate the status of each call and the ability to manage multiple calls at one time, a problem has arisen when a caller is placed on hold and receives another call at the same time. The following scenario will illustrate the problem:
caller places a call and is then placed on hold;
while caller is on hold they receive another call on line 2;
caller has to decide whether to pick up the call on line 2 or to idle on hold with line 1;
pick up line 2: if the caller picks up on line 2 they run the risk of not being on the phone when taken off hold on line 1. The participant on line 1 (previously putting caller on hold) has no way of know if the caller has dropped the call due to bad reception, being hung up on for being on hold for too long, or is simply on the other line;
ignore line 2: If the caller doesn't pick up line 2 they obviously have to ignore the incoming call leaving them sitting idle on hold with line 1 in an unproductive manor.

This same scenario can be expanded to describe situation with smart phones that are able to handle more than 2 calls at once (iPhone, Android, and other smart phones and programmable phones with visual on hold indicators):
Caller places a call and is then placed on hold;
while caller is on hold they receive another call on line 2. Caller places line 1 on hold and answers line 2;
   line 2 then also places caller on hold. Caller receives a call on line 3;
caller places line 2 on hold to pick up line 3;
the caller then has to continuously transition between the three lines to determine whether or not line 1 and 2 has taken the caller of hold.

Currently, none of the phones that allow a caller to visually manipulate multiple calls at one time offer the capability for a caller to be notified when they have been taken off hold on a line they have navigated away from due to secondary and tertiary incoming phone calls.

These smart phones have become an integral tool used in conducting business in a continuously growing number of industries, all of which would benefit from a tool that enables the user to manipulate multiple calls at once.

### SUMMARY OF THE INVENTION

The invention described herein solves these problems for the smart phone and programmable phone user. The inventions consist of software written by the inventors, which is installed on the phone and takes control of the on-hold process during calls made using the phone (either inbound or outbound). In software, using custom on-hold messages and key press prompts made to the callers and answerers who are on hold, indicates visually using the phones visual on hold indicators to indicate whether a person on hold has recently (last 10 or 15 seconds) pressed a key on their phone to indicate that they are actively connected to the user's phone, and have not placed the user on hold.

### BRIEF DESCRIPTION OF THE DRAWINGS

FIG. 1 is an overview of the components of the On Hold Software Management System (“OHSMS”) (the software invented by the inventors) and their interaction with each other.

FIG. 2 describes the Software's interaction with the process of making phone calls.

### DETAILED DESCRIPTION OF THE PREFERRED EMBODIMENT

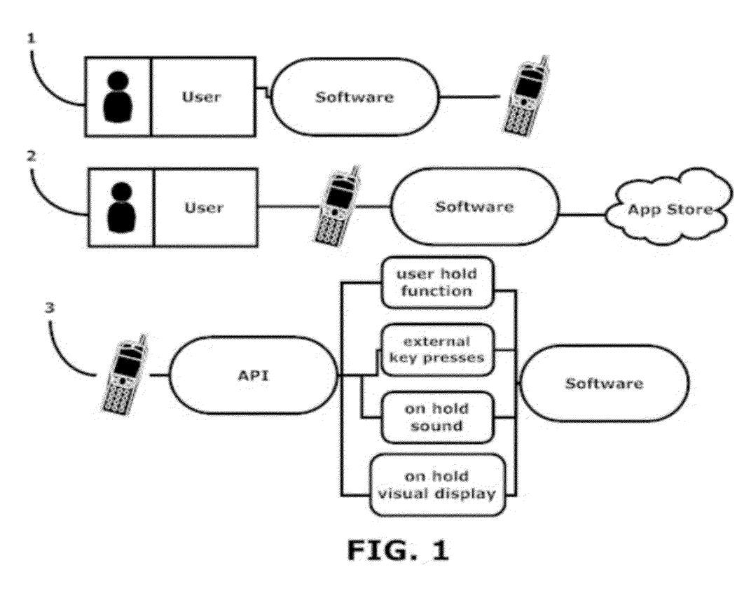

FIG. 1 is an overview of the components of the On Hold Software Management System (“OHSMS”) (the software invented by the inventors) and their interaction with each other.

FIG. 1, smart phone and user, item 1. The OHMS is installed on a smart phone and operates by interacting with the user of the phone through the phone's application programming interface (“API”).

FIG. 1, smart phone software installation, applications (“apps”) and user, item 2. The OHSMS is installed by the user on the smart phone, usually by download from one of the app stores.

The user is asked by the phone system API (application programming interface) through the interactive installation program, using the phone, to state the user's name, which is recorded for further use by the OHSMS.

FIG. 1, smart phone system API, item 3. The OHSMS installs itself into the smart phone system API (application programming interface) so that it is:
notified of events: call being placed on hold and off hold by the phone user;
key presses by the other party or parties to the call;
on hold sound generation;
control over the visual display of on hold status on the phone screen.

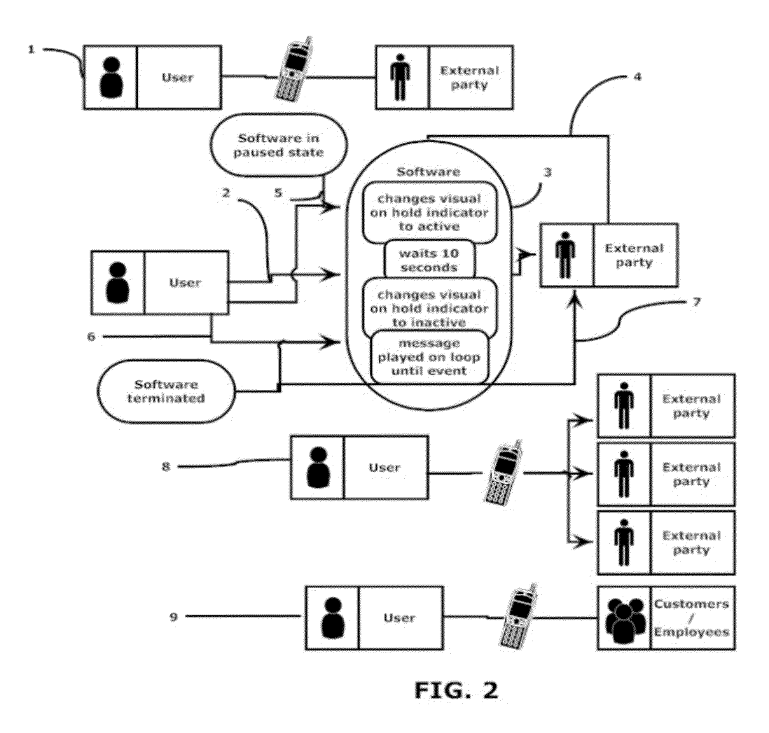

FIG. 2 describes the OHSMS's interaction with the process of making phone calls.

FIG. 2, user calls an external party using a smart phone, item 1. The user calls an external party on a smart phone. The phone system API launches the OHSMS and gives it access to the particular call. The software enters a paused state awaiting event notifications from the API.

FIG. 2, user puts the external party on hold, item 2. The user puts the external party on hold. The phone system API notifies the OHSMS that the call is on hold.

FIG. 2, user puts the external party on hold, OHSMS on hold process, item 3. The OHSMS:
changes the visual on hold indicator on the phone to the OHSMS's custom (and different) indicator for an active caller on hold;
waits 10 seconds;
changes the visual on hold indicator on the phone to the OHSMS's indicator for an inactive caller on hold;
verbalizes a message to the on hold external party to the effect of “please press One to indicate that you are still waiting on hold, and an alert will be delivered to <pre recorded user name recorded in the installation process> that you are still waiting on hold;
repeats the message continuously until the external party presses a key or the user takes the call off hold or the call is terminated.

FIG. 2, party presses a key, item 4. If the external party presses a key, the procedure described in the preceding paragraph is repeated.

FIG. 2, user takes the call off hold, item 5. If the user takes the call off hold, then the OHSMS stops the message, returns the visual on hold indicator to its default state, and enters a paused state awaiting events from the phone system API.

FIG. 2, user terminates the call, item 6. If the user terminates the call, then the OHSMS terminates its thread related to this call is terminated.

FIG. 2, external party terminates the call, item 7. If the external party terminates the call, then the OHSMS terminates once the API terminates the call thread.

FIG. 2, multiple separate calls call, item 8. The phone API launches a separate thread of the OHSMS for every separate call.

FIG. 2, multiple separate calls call, item 9. A conference call with multiple external parties on it is treated by the OHSMS as a single call. Thus, if any external party presses a key, the OHSMS shows the user that the callers on hold are active. Only if no on hold external party presses a key is the entire call shown as inactive.

This process for incoming and outgoing calls can be repeated until the capacity of the phone to make and receive simultaneous calls is reached.

The OHSMS as described can be extended to any phone system that can visually display the status of callers and manipulate on hold systems. The OHSMS as described can be extended to use any user notification system including vibration and noise.

### Additional Embodiments

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### Conclusions, Ramifications and Scope

The embodiment of the invention solves the problems herein described in a efficient and elegant manner. The user of the phone can place any number of external parties on hold and still have an immediate visual indication on the hand set of the current active/inactive hold status of all external parties. This improves phone use efficiency for all parties, but reducing hold waits and the necessity for inefficient call backs and voice mails.

1. A method of operating a programmable telephone that enables real-time user-operated communication with respect to on-hold status, comprising:
a. placing a communication with a second telephone on hold;
b. receiving from said second telephone a signal, where said signal correlates to whether said programmable telephone is on hold with said second telephone; and
c. indicating whether said programmable telephone has received said signal.

2. The method of claim 1, further comprising communicating a message either to said second telephone or to the user of said second telephone.

3. The method of claim 2, wherein such message communicates how said second telephone or the user of said second telephone can communicate how to signal that said second telephone or the user of said second telephone is no longer on hold.

4. The method of claim 3, wherein said message comprises “press a telephone key” or an equivalent thereof.

5. The method of claim 4, wherein said message is a pre-recorded sound.

6. The method of claim 1, wherein said indicating is via a display on said programmable telephone.

7. The method of claim 1, further comprising:
a. placing a communication with a third telephone on hold;
b. receiving from said third telephone a signal, where said signal correlates to whether said programmable telephone is on hold with said third telephone; and
c. indicating whether said programmable telephone has received said signal.

8. A programmable telephone that enables real-time user-operated communication with respect to on-hold status, comprising:
a. a means of placing a communication with a second telephone on hold;
b. a means of receiving from said second telephone a signal, where said signal correlates to whether said programmable telephone is on hold with said second telephone; and
c. a means of indicating whether said programmable telephone has received said signal.

9. The programmable telephone of claim 1, further comprising a means of communicating a message either to said second telephone or to the user of said second telephone.

10. The programmable telephone of claim 1, wherein such message communicates how said second telephone or the user of said second telephone can communicate how to signal that said second telephone or the user of said second telephone is no longer on hold.

11. The programmable telephone of claim 1, wherein said message comprises “press a telephone key” or an equivalent thereof.

12. The programmable telephone of claim 1, wherein said message is a pre-recorded sound.

13. The programmable telephone of claim 1, wherein said indicating is via a display on said programmable telephone.

14. The programmable telephone of claim 1, further comprising:
a. a means of placing a communication with a third telephone on hold;
b. a means of receiving from said third telephone a signal, where said signal correlates to whether said programmable telephone is on hold with said third telephone; and
c. a means of indicating whether said programmable telephone has received said signal.
